(19) United States
(12) Patent Application Publication
(10) Pub. No.: US 2025/0230900 A1
(43) Pub. Date: Jul. 17, 2025

(54) CONTROL SYSTEM AND METHOD FOR PREVENTING HYDROGEN BOIL-OFF LOSSES

(71) Applicant: Volvo Truck Corporation, Goteborg (SE)

(72) Inventor: Parthav Desai, Goteborg (SE)

(21) Appl. No.: 19/008,141

(22) Filed: Jan. 2, 2025

(30) Foreign Application Priority Data
Jan. 11, 2024 (EP) 24151396.9

(51) Int. Cl. F17C 5/02

(52) U.S. Cl. CPC F17C 5/02; F17C 2221/012; F17C 2223/0161; F17C 2250/032; F17C 2250/0408; F17C 2250/0439; F17C 2250/0478; F17C 2260/035; F17C 2265/065; F17C 2270/0178

(57) ABSTRACT

Control system and method for controlling state of hydrogen charge in hydrogen storage system in a vehicle to prevent hydrogen boil-off losses. The control system obtains information about predetermined stop duration and location for vehicle; obtains information on required hydrogen usage for reaching predetermined stop location from a current location of the vehicle; obtains information on a maximum hydrogen level of the hydrogen storage system to prevent hydrogen boil-off losses when the vehicle reaches the predetermined stop location and the stop duration starts; and generates a control signal for controlling the state of hydrogen charge of the hydrogen storage system based on a current hydrogen level in the hydrogen storage system when the vehicle is at the current location, the required hydrogen usage for reaching the predetermined stop location and the maximum hydrogen level of the hydrogen storage system to prevent hydrogen boil-off losses.

### PRIORITY APPLICATIONS

The present application claims priority to European Patent Application No. 24151396.9, filed on Jan. 11, 2024, and entitled “CONTROL SYSTEM AND METHOD FOR PREVENTING HYDROGEN BOIL-OFF LOSSES,” which is incorporated herein by reference in its entirety.

### TECHNICAL FIELD

The disclosure relates generally to controlling a state of hydrogen charge in a hydrogen storage system. In particular aspects, the disclosure relates to a control system and method for controlling a state of hydrogen charge in a hydrogen storage system comprised in a vehicle to prevent hydrogen boil-off losses.

The disclosure can be applied in any vehicles, such as trucks, cars, heavy-duty trucks, buses, construction equipment, marine vessels etc. Although the disclosure will be described with respect to a particular vehicle, the disclosure is not restricted to any particular vehicles.

### BACKGROUND

A fuel cell electric vehicle (FCEV) is an electric vehicle that uses a fuel cell, sometimes in combination with a small battery or supercapacitor, to power its onboard electric motor. Fuel cells in vehicles generate electricity generally using oxygen from the air and compressed hydrogen. Cryogenic hydrogen is a good way to carry a large amount of fuel for long range fuel cell or hydrogen internal combustion engine (ICE) powered trucks. It is also potentially a cheap way to source and store hydrogen. But it suffers from boil-off losses. Boil-off losses occur when gaseous hydrogen has to be released from a cryogenic tank due to liquid hydrogen evaporating. Boil-off losses are a substantial drawback for all areas in which liquid hydrogen is discussed as a potential fuel to limit the climate impact.

Cryogenic hydrogen is a challenging fuel to handle, because it has to be stored at about 20 K (−253° C.) to remain liquid. Heat input from the environment into a cryogenic tank leads to hydrogen evaporating, which increases the pressure. Cryogenic hydrogen in a vehicle is stored in an insulated tank. But some heat penetration from ambient always occurs. This will lead to heating up the tank. This results in increased pressure in the tank. When the maximum tank pressure is reached, gaseous hydrogen must be vented to the environment to limit the pressure rise. So, if the vehicle is stopped for a long time, the pressure may increase so much that hydrogen needs to be vented from the tank which causes boil-off losses.

There are hardware solutions which aim to make the hydrogen tank more insulated. This reduces boil-off losses but potentially also adds cost, weight and reduces space for hydrogen storage. In view of the above, there is a strive to develop further improved technology relating to control of hydrogen storage systems.

### SUMMARY

The present disclosure provides a control system and method for controlling a state of hydrogen charge in a hydrogen storage system to prevent or reduce hydrogen boil-off losses. That is the level of hydrogen in a cryogenic hydrogen tank of a vehicle may be controlled to prevent or reduce hydrogen boil-off losses by controlling the refueling level of the hydrogen tank or by controlling the hydrogen consumption in the vehicle.

The possibility of venting the gaseous hydrogen is lower if the hydrogen level in the tank is lower. So, by controlling the hydrogen level in the tank, one can reduce or eliminate boil-off losses.

According to a first aspect of the disclosure, a control system for controlling a state of hydrogen charge in a hydrogen storage system comprised in a vehicle to prevent hydrogen boil-off losses is provided.

The control system is configured to obtain information about a predetermined stop duration and location for the vehicle. The control system is further configured to obtain information on a required hydrogen usage for reaching the predetermined stop location from a current location of the vehicle. The control system is further configured to obtain information on a maximum hydrogen level of the hydrogen storage system to prevent hydrogen boil-off losses when the vehicle reaches the predetermined stop location and the predetermined stop duration starts. The control system is further configured to generate a control signal for controlling the state of hydrogen charge of the hydrogen storage system based on a current hydrogen level in the hydrogen storage system when the vehicle is at the current location, the required hydrogen usage for reaching the predetermined stop location and the maximum hydrogen level of the hydrogen storage system to prevent hydrogen boil-off losses such that the hydrogen level in the hydrogen storage system when the vehicle reaches the predetermined stop location is equal or less than the maximum hydrogen level in the hydrogen storage system to prevent hydrogen boil-off.

The first aspect of the disclosure may seek to reduce hydrogen boil-off losses. By obtaining information about the predetermined stop duration and location for the vehicle, i.e. motor stopping time, temperature of the stop location etc., the maximum hydrogen level of the hydrogen storage system to prevent hydrogen boil-off losses at stop location can be determined. The hydrogen level in the hydrogen storage system can be controlled in advance before the vehicle reaches the predetermined stop location such that the maximum hydrogen level to prevent hydrogen boil-off losses at stop location is not exceeded, so the maximum tank pressure will not be reached, and venting gaseous hydrogen to outside is avoided, hydrogen boil-off losses is prevented.

Optionally in some examples, including in at least one preferred example, the control system is configured to generate a control signal for controlling the state of hydrogen charge of the hydrogen storage system by controlling a refueling level of the hydrogen storage system or controlling hydrogen consumption of the vehicle. By controlling the hydrogen consumption or the hydrogen refueling level before the vehicle reaches the predetermine stop location, the maximum hydrogen level to prevent hydrogen boil-off losses at stop location is not exceeded, so the maximum tank pressure will not be reached, and venting gaseous hydrogen to outside is avoided, hydrogen boil-off losses is prevented.

Optionally in some examples, including in at least one preferred example, the control system may be configured to calculate a difference between the current hydrogen level in the hydrogen storage system and the required hydrogen usage for reaching the predetermined stop location. If the difference is larger than the maximum hydrogen level in the hydrogen storage system to prevent hydrogen boil-off, the control system is configured to generate a control signal to increase hydrogen consumption in the vehicle, or if the vehicle is at a refueling station, the control system is configured to generate a control signal to stop hydrogen refueling. If the difference is smaller than the maximum hydrogen level in the hydrogen storage system to prevent hydrogen boil-off losses and the vehicle is at a refueling station, the control system is configured to generate a control signal to control the refueling level of the hydrogen storage system based on the difference between the current hydrogen level in the hydrogen storage system and the required hydrogen usage for reaching the predetermined stop location. Since the current level of the hydrogen storage system, the required usage of hydrogen to reach the predetermine stop location and the maximum hydrogen level to prevent hydrogen boil-off losses at stop location have been taken into account when determining control strategy, the boil-off loss is prevented or reduced to the utmost extent.

Optionally in some examples, including in at least one preferred example, the control system may be configured to determine a maximum refueling hydrogen level based on the current hydrogen level, the required hydrogen usage for reaching the predetermined stop location and the maximum hydrogen level to prevent hydrogen boil-off. For example, the control system may be configured to determine a maximum refueling hydrogen level based on the difference between the current hydrogen level in the hydrogen storage system and the required hydrogen usage for reaching the predetermined stop location; and inform a user and/or a vehicle system and/or a fuel station system about the maximum refueling hydrogen level such that the hydrogen refueling is stopped before or when the maximum refueling hydrogen level is reached. By determining a maximum refueling hydrogen level and informing it to a user and/or a vehicle system and/or a fuel station system, the hydrogen refueling may be controlled such that the maximum hydrogen level to prevent hydrogen boil-off losses at stop location is not exceeded when the vehicle reaches the stop location, so the maximum tank pressure will not be reached, and venting gaseous hydrogen to outside can be avoided and hydrogen boil-off losses can be reduced.

Optionally in some examples, including in at least one preferred example, the control system may be configured to generate a control signal to increase hydrogen consumption in the vehicle by charging an energy storage system of the vehicle. The energy storage system may be charged such that the hydrogen level in the hydrogen storage system when the vehicle reaches the predetermined stop location is lower than or equal to the maximum hydrogen level in the hydrogen storage system to prevent hydrogen boil-off losses; or the energy storage system may be charged as much as possible until the vehicle reaches the predetermined stop location. By charging the energy system, the extra hydrogen can be consumed so that the maximum hydrogen level in the hydrogen storage system to prevent hydrogen boil-off losses at stop location is not exceed and hydrogen boil-off losses can be prevented.

According to a second aspect of the disclosure, a method performed in the control system for controlling a state of hydrogen charge in a hydrogen storage system comprised in a vehicle to prevent hydrogen boil-off losses is provided. The control system obtains information about a predetermined stop duration and location for the vehicle. The control system further obtains information on a required hydrogen usage for reaching the predetermined stop location from a current location of the vehicle. The control system further obtains information on a maximum hydrogen level of the hydrogen storage system to prevent hydrogen boil-off losses when the vehicle reaches the predetermined stop location and the predetermined stop duration starts. The control system generates a control signal for controlling the state of hydrogen charge of the hydrogen storage system based on a current hydrogen level in the hydrogen storage system when the vehicle is at the current location, the required hydrogen usage for reaching the predetermined stop location and the maximum hydrogen level of the hydrogen storage system to prevent hydrogen boil-off losses such that the hydrogen level in the hydrogen storage system when the vehicle reaches the predetermined stop location is equal or less than the maximum hydrogen level in the hydrogen storage system to prevent hydrogen boil-off losses.

The second aspect of the disclosure may seek a method to reduce hydrogen boil-off losses. By obtaining information about the predetermined stop duration and location for the vehicle, i.e. motor stopping time, temperature of the stop location etc., the maximum hydrogen level of the hydrogen storage system to prevent hydrogen boil-off losses at stop location can be determined. The hydrogen level in the hydrogen storage system can be controlled in advance before the vehicle reaches the predetermined stop location such that the maximum hydrogen level to prevent hydrogen boil-off losses at stop location is not exceeded, so the maximum tank pressure will not be reached, and venting gaseous hydrogen to outside is avoided, hydrogen boil-off losses is prevented.

The control method is implemented by software and based on data and information. No hardware added, so no extra cost on hardware. No modification and weight added to the hydrogen storage system, and the space for hydrogen storage is not reduced.

According to a third aspect of the disclosure, a vehicle comprising a control system described above is provided. Technical benefits may include reducing hydrogen boil-off losses of the hydrogen storage system comprised in the vehicle can and energy saving.

The disclosed aspects, examples (including any preferred examples), and/or accompanying claims may be suitably combined with each other as would be apparent to anyone of ordinary skilled in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary schematic block diagram showing an exemplary control system together with a hydrogen storage system and an energy storage system comprised in a vehicle, according to an example; and

FIG. 2 is an exemplary flow chart showing a method for controlling a state of hydrogen charge, according to an example.

FIG. 3 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The present disclosure provides a control system and method therein for controlling a state of hydrogen charge in a hydrogen storage system to prevent or reduce hydrogen boil-off losses. The control system may generally be refereed as a computer system comprising a processing circuitry configured to control the state of hydrogen charge in a hydrogen storage system to prevent or reduce hydrogen boil-off losses. For example, the level of hydrogen in a cryogenic hydrogen tank of a vehicle can be controlled to prevent or reduce hydrogen boil-off losses by controlling the refueling level of the hydrogen tank or by controlling the hydrogen consumption of the vehicle.

The term “hydrogen” used herein may be referred to liquid hydrogen, cryogenic hydrogen, cryo-compressed hydrogen, or any other form of hydrogen that is stored at cryogenic temperatures.

The term “state of hydrogen charge in a hydrogen storage system” used herein is a general term which may refer to “hydrogen level in a tank” or “level of hydrogen in a tank” defined for liquid hydrogen. Cryo-compressed hydrogen for example may behave like a gas. So the level of hydrogen in a tank should in general mean the state of hydrogen charge in a hydrogen storage system.

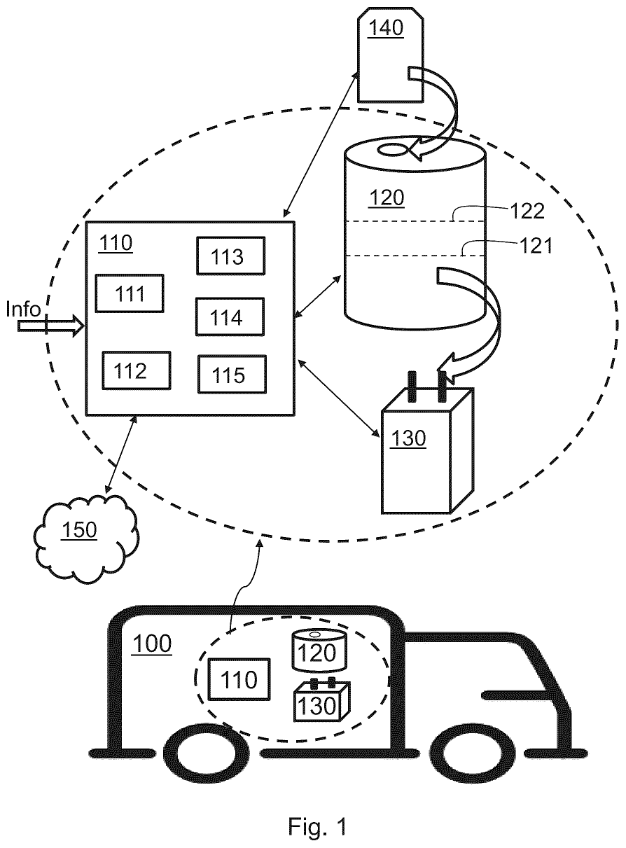

FIG. 1 is a schematic block diagram showing an example of a control system 110 comprised in a vehicle 100 for controlling a state of hydrogen charge in a hydrogen storage system, e.g. a hydrogen tank 120, comprised in the vehicle 100. The control system 110 which may also be referred as a computer system comprising a processing circuitry. The control system 110 may be a control unit in or a part of an energy management system of the vehicle 100 used to control operating of electric motor, energy using and optimization, battery charging etc. The control system 110 may receive various information from internal and/or external system, e.g. data or inputs from sensors comprised in the vehicle 100, data or information from a central system 150, e.g. a cloud server, a Telematics server or a local server storing information and databases for a group of similar type of vehicles, commands from driver etc., to generate appropriate control signals for controlling other internal and/or external systems or causing other internal and/or external systems to act. The vehicle 100 may comprise other units or modules, where an energy storage system e.g. a battery 130, is shown. The control system 110, hydrogen tank 120 and energy storage system 130 shown in the dotted-line circle inside the vehicle 100 are further illustrated in more detail in the enlarged dotted-line circle to show the interactions and relations between these units or modules. A fuel station system 140 is also shown in the figure, from which the hydrogen tank 120 may get hydrogen refueling.

To perform the method for controlling a state of hydrogen charge in the hydrogen storage system 120 to prevent or reduce hydrogen boil-off losses, the control system 110 may comprise modules or units as shown in FIG. 1. The control system 110 may comprise a receiving module 111, a sending module 112, a determining module 113, a processing module 114 etc. The control system 100 may comprise other units or modules, e.g. a memory 115.

The control system 110 is configured to, by means of e.g. the receiving module 111 being configured to, obtain information about a predetermined stop duration and location for the vehicle 100. The control system 110 may use mission management information or information about the vehicle schedule so that it knows the vehicle 100 is approaching a long stop e.g. a stop for 2-3 days or a weekend stop. This information may also be provided by the driver inside the vehicle. During the predetermined stop duration, the vehicle 100 will not consume any hydrogen stored in the hydrogen storage system 120.

The control system 110 is configured to, by means of e.g. the receiving module 111 being configured to, obtain information on a required hydrogen usage for reaching the predetermined stop location from a current location of the vehicle 100. This information may be obtained from the energy management system or any other system on board of the vehicle 100. For example, there may be a system that calculates the range of the vehicle. Such a system will have these calculations already included.

The control system 110 may be configured to determine or calculate the required hydrogen usage for reaching the predetermined stop location by being configured to use information about the predetermined stop location, map information and information about hydrogen consumption calculated by another system on board of the vehicle 100. For example, based on the speed, weight, traffic, information about slope of road, type of road, as well as vehicle information such as different kinds of resistive forces, it is possible to calculate the power required to propel the vehicle. This power can be converted into hydrogen consumption using the efficiency of the vehicle systems such as fuel cell system as well as other power consumption such as auxiliary power consumption. A simple software code may be implemented as a part of the control system 110 to calculate the required hydrogen usage for reaching the predetermined stop location. Another way to calculate the required hydrogen usage for reaching the predetermined stop location may just check the historic fuel consumption and project it forward. So if the vehicle 100 has been using xKg/km hydrogen, one can just multiply this value by the remaining distance to get the required hydrogen usage for reaching the predetermined stop.

The control system 110 is configured to, by means of e.g. the receiving module 111 or the determining module 113 being configured to, obtain information on the maximum hydrogen level of the hydrogen storage system to prevent hydrogen boil-off losses when the vehicle 100 reaches the predetermined stop location and the predetermined stop duration starts, which is referred as the maximum hydrogen level to prevent hydrogen boil-off losses at stop location and indicated by a dotted line 121. As discussed in the background, if the stop duration is long and the hydrogen tank will slowly warm up, causing liquid hydrogen to vaporize and leading to an increased pressure in the tank. When the maximum tank pressure is reached, since the vehicle 100 will not consume any hydrogen stored in the hydrogen storage system during the stop duration, the gaseous hydrogen must be vented to the environment to limit the pressure rise. This causes boil-off losses. To prevent this boil-off loss, the hydrogen level in the hydrogen storage system 120 when the vehicle 100 reaches the predetermined stop location must be equal or less than the maximum hydrogen level 121 to prevent hydrogen boil-off losses at stop location.

The control system 110 may obtain information on the maximum hydrogen level 121 to prevent hydrogen boil-off losses in several ways. For example, the control system 110 may be configured to, by means of e.g. the processing module 114 being configured to, calculate the maximum hydrogen level 121 of the hydrogen storage system 120 to prevent hydrogen boil-off losses based on relative parameters, such as the predetermined stop duration, the ambient conditions of the hydrogen storage system, the ambient temperature, the type and design of the hydrogen storage system and the thermal or thermodynamic state of the hydrogen storage system.

For example, the control system 110 may be configured to determine the maximum hydrogen level 121 of the hydrogen storage system to prevent hydrogen boil-off losses by using a look up table with information on vehicle stopping duration before hydrogen boil-off starts versus state of hydrogen charge of the hydrogen storage system. Alternatively, a pre-built model based on the type and design of the hydrogen storage system 120 may also be used by the control system 110 to determine the maximum hydrogen level 121 of the hydrogen storage system to prevent hydrogen boil-off losses by inputting relative parameters such as stopping duration, current state of hydrogen charge and ambient condition of the hydrogen storage system, e.g. ambient temperature, thermal or thermodynamic state of the hydrogen storage system etc.

The relative parameters listed above to determine the maximum hydrogen level 121 of the hydrogen storage system to prevent hydrogen boil-off losses are only examples. The skilled person will recognize that many changes and modifications to the relative parameters listed above may be made within the scope of the present disclosure. For example, any other parameters or more parameters which may have influence on the maximum hydrogen level 121 of the hydrogen storage system to prevent hydrogen boil-off losses may also be included in the relative parameters. Any changing, adding, replacing, or removing any of these listed parameters will still be within the scope of the present disclosure.

Alternatively, the control system 110 may be configured to receive the maximum hydrogen level 121 of the hydrogen storage system 120 to prevent hydrogen boil-off losses from another system on board of the vehicle 100 or from the central system 150. The central system 150 or another system on board of the vehicle 100 may use a look up table or a model to determine the maximum hydrogen level 121 of the hydrogen storage system 120 to prevent hydrogen boil-off losses based on relative parameters, such as the predetermined stop duration, the ambient conditions of the hydrogen storage system, the ambient temperature, the type and design of the hydrogen storage system and the thermal or thermodynamic state of the hydrogen storage system. The central system 150 or another system on board of the vehicle 100 may send the maximum hydrogen level 121 of the hydrogen storage system 120 to prevent hydrogen boil-off losses to the control system 110 in response to a request received from the control system 110.

After the information on the maximum hydrogen level 121 of the hydrogen storage system 120 to prevent hydrogen boil-off losses is obtained, the control system 110 is configured to, by means of e.g. the determining module 113 being configured to, generate a control signal for controlling the state of hydrogen charge of the hydrogen storage system 120 based on a current hydrogen level, e.g. indicated by a dotted line 122, in the hydrogen storage system 120 when the vehicle 100 is at the current location, the required hydrogen usage for reaching the predetermined stop location and the maximum hydrogen level 121 of the hydrogen storage system 120 to prevent hydrogen boil-off losses such that the hydrogen level in the hydrogen storage system 120 when the vehicle 100 reaches the predetermined stop location is equal or less than the maximum hydrogen level 121 in the hydrogen storage system 120 to prevent hydrogen boil-off.

The control system 110 may be configured to generate a control signal for controlling the state of hydrogen charge of the hydrogen storage system 120 such that a refueling level of the hydrogen storage system 120 or hydrogen consumption of the vehicle is controlled.

The control system 110 may be configured to calculate a difference between the current hydrogen level 122 in the hydrogen storage system and the required hydrogen usage for reaching the predetermined stop location. If the difference is larger than the maximum hydrogen level 121 in the hydrogen storage system 120 to prevent hydrogen boil-off, the control system 110 is configured to generate a control signal to e.g., the energy management system of the vehicle 100, to increase hydrogen consumption in the vehicle 100, or if the vehicle is at a refueling station, the control system 110 may be configured to send a stop signal to the fuel station or inform the driver to stop hydrogen refueling. If the difference is smaller than the maximum hydrogen level 121 in the hydrogen storage system to prevent hydrogen boil-off losses and the vehicle 100 is at a refueling station, the control system 110 is configured to send a control signal to the fuel station or a system on board of the vehicle, or inform the driver to control the refueling level of the hydrogen storage system.

The control system 110 may be configured to determine a maximum refueling hydrogen level based on the current hydrogen level 122, the required hydrogen usage for reaching the predetermined stop location and the maximum hydrogen level 121 to prevent hydrogen boil-off losses. For example, the control system 110 may be configured to determine a maximum refueling hydrogen level based on the difference between the current hydrogen level 122 in the hydrogen storage system and the required hydrogen usage for reaching the predetermined stop location. Then the control system 110 informs a user and/or a vehicle system and/or a fuel station system about the maximum refueling hydrogen level 121 such that the hydrogen refueling is stopped before or when the maximum refueling hydrogen level is reached. For example, the control system 110 may inform the driver about this maximum refueling limit or communicates this maximum refueling limit to another system e.g. the fuel station itself that has capability to stop the refueling, or some system on the vehicle that can stop refueling at a certain point. The driver or the other system can then decide to stop refueling at the desired fuel level. By informing the fuel station before refueling about the level of hydrogen to be filled or any other parameter related to hydrogen refueling level, the refilling level of the hydrogen storage system 120 can be controlled. To control the hydrogen refueling, there may be different communication protocols and may vary from location to location and may also be based on the type of cryogenic hydrogen which is refilling. So the exact communication will differ depending on different applications and scenarios.

The control system 110 may be configured to generate a control signal to increase hydrogen consumption in the vehicle 100 by charging an energy storage system 130 of the vehicle 100. The energy storage system 130 may be charged such that the hydrogen level in the hydrogen storage system 120 when the vehicle reaches the predetermined stop location is lower than or equal to the maximum hydrogen level 121 in the hydrogen storage system 120 to prevent hydrogen boil-off losses. The energy storage system 130 may also be charged as much as possible until the vehicle 100 reaches the predetermined stop location.

The maximum hydrogen level 121 in the hydrogen storage system 120 to prevent hydrogen boil-off losses discussed above is referred as the maximum hydrogen level to prevent hydrogen boil-off losses at stop location when the vehicle 100 is at the predetermined stop location and the stop time starts. The maximum hydrogen level in the hydrogen storage system 120 to prevent hydrogen boil-off losses may also be referred as the maximum hydrogen level to prevent hydrogen boil-off losses when the vehicle 100 is at the current location. By adding the required usage from the refueling station to the stop location with the maximum hydrogen level to prevent boil-off losses at stop location, one can arrive at the maximum hydrogen level to prevent hydrogen boil-off losses at current location. If the current hydrogen level 122 in the hydrogen storage system 120 is larger than this level, the control system 110 will try to find ways to utilize this extra hydrogen. For example, the control system 110 may check the state of charge (SoC) target of the battery 130. The SoC target is the targeted level of charge the battery should have. This is different from the actual SoC of the battery which varies based on local conditions such as braking etc. The control system 110 may calculate how much the battery can be charged such that the hydrogen level in the tank can be brought to the maximum hydrogen level 121 to prevent hydrogen boil-off losses at stop location. The control system 110 then generates a control signal to, e.g. the energy management system, to cause a ramping up of the SoC of the battery so that it reaches this higher targeted SoC by stop time.

The battery in a fuel cell vehicle has a maximum SoC level. This level can be the maximum allowed limit or may be modified based on the location that the vehicle is stopping at. By making sure that the battery SoC increases as much as needed up to the maximum level, the hydrogen consumption can be increased. During normal driving, the battery may not reach the maximum allowed level at the predetermined stop location. By using hydrogen in the fuel cell, the fuel cell can produce excess electric energy that can be used to further increase the battery SoC level as needed up to the maximum allowed level. The battery SoC and the power split between the fuel cell and battery while propelling the vehicle is determined by e.g. the energy management system that is designed specifically for this. By communicating to the energy management system, the extra hydrogen or how much the battery can be charged or any parameter related to the maximum hydrogen level to prevent hydrogen boil-off losses at stop or current location, the energy management system may decide how to charge the battery and take care of the best way to increase the battery energy before the predetermined stop.

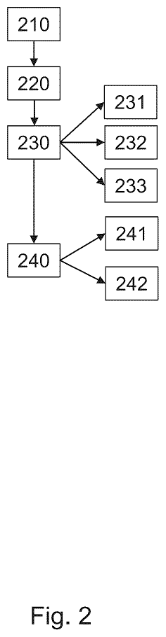

A method performed by the control system 110 for controlling a state of hydrogen charge in a hydrogen storage system 120 of a vehicle 100 will be described with reference to FIG. 2. The method comprises at least one of the following actions, which may be performed in any suitable order.

### Action 210

The control system 110 obtains information about a predetermined stop duration and location for the vehicle 100. The information may be obtained from mission management of the vehicle or schedule management of the vehicle. This information may also be provided by the driver inside the vehicle.

### Action 220

The control system 110 obtains information on a required hydrogen usage for reaching the predetermined stop location from a current location of the vehicle 100. The information may be obtained from another system on board of the vehicle 100 or calculated by the control system 110 using information about the predetermined stop location, map information and information about hydrogen consumption data of the vehicle 100.

### Action 230

The control system 110 obtains information on a maximum hydrogen level 121 of the hydrogen storage system 120 to prevent hydrogen boil-off losses when the vehicle 100 reaches the predetermined stop location and the stop duration starts. The information may be obtained from another system on board of the vehicle 100 or from the central system 150. The maximum hydrogen level 121 of the hydrogen storage system 120 to prevent hydrogen boil-off losses may also be or calculated or determined by the control system 110 based on the relative parameters.
The control system 110 may, in Action 231, calculate the maximum hydrogen level 121 of the hydrogen storage system 120 to prevent hydrogen boil-off losses based on the relative parameters such as predetermined stop duration, the ambient conditions of the hydrogen storage system, the ambient temperature, the type and design of the hydrogen storage system and the thermal or thermodynamic state of the hydrogen storage system.
The control system 110 may, in Action 232, determine the maximum hydrogen level 121 of the hydrogen storage system 120 to prevent hydrogen boil-off losses by using a look up table with information on vehicle stopping duration before hydrogen boil-off losses starts versus state of hydrogen charge of the hydrogen storage system, or by using a pre-built model based on a type and design of the hydrogen storage system 120 with relative parameters related to e.g. stopping duration, current state of hydrogen charge and ambient condition of the hydrogen storage system.
The control system 110 may, in Action 233, receive the maximum hydrogen level 121 of the hydrogen storage system 120 to prevent hydrogen boil-off losses from another system on board of the vehicle or from the central system 150.

### Action 240

The control system 110 generates a control signal for controlling the state of hydrogen charge of the hydrogen storage system 120 based on a current hydrogen level 122 in the hydrogen storage system 120 when the vehicle 100 is at the current location, the required hydrogen usage for reaching the predetermined stop location and the maximum hydrogen level 121 of the hydrogen storage system 120 to prevent hydrogen boil-off losses such that the hydrogen level in the hydrogen storage system 120 when the vehicle 100 reaches the predetermined stop location is equal or less than the maximum hydrogen level 121 in the hydrogen storage system to prevent hydrogen boil-off losses.
The control system 110 may generate a control signal for controlling, in Action 241, a refueling level of the hydrogen storage system.
The control system 110 may determine a maximum refueling hydrogen level based on a difference between the current hydrogen level in the hydrogen storage system 120 and the required hydrogen usage for reaching the predetermined stop location; or determining a maximum refueling hydrogen level based on the current hydrogen level 122, the required hydrogen usage for reaching the predetermined stop location and the maximum hydrogen level 121 to prevent hydrogen boil-off.
The control system 110 may inform or send a signal to a user and/or a vehicle system and/or a fuel station system about the maximum refueling hydrogen level such that the hydrogen refueling is stopped before or when the maximum refueling hydrogen level is reached.
The control system 110 may generate a control signal for controlling, in Action 242, hydrogen consumption of the vehicle 100.
The control system 110 may generate a control signal to cause charging the energy storage system 130 such that the hydrogen level in the hydrogen storage system 120 when the vehicle 100 reaches the predetermined stop location is lower than or equal to the maximum hydrogen level 121 in the hydrogen storage system 120 to prevent hydrogen boil-off losses.
The control system 110 may generate a control signal to cause charging the energy storage system 130 as much as possible until the vehicle 100 reaches the predetermined stop location.

The control system 110 and the method described above may be implemented in any vehicles or FCEVs as shown in FIG. 1. The vehicle 100 comprises the control system 110 described above. The control system 110 can be applied in any type of vehicles or machines having hydrogen storage system such as wagons, motor vehicles, cars, trucks, buses, railed vehicles e.g. trains, trams, watercraft e.g. ships, boats, amphibious vehicles e.g. screw-propelled vehicle, hovercraft, aircraft e.g. airplanes, helicopters, aerostat and spacecraft etc.

To summarize, the disclosure provides a control system 110 and method for controlling the state of hydrogen charge in a hydrogen storage system comprised in a vehicle 100 to prevent hydrogen boil-off losses. By obtaining information about the predetermined stop duration and location for the vehicle 100, the maximum hydrogen level of the hydrogen storage system to prevent hydrogen boil-off losses at stop location can be determined. The hydrogen level in the hydrogen storage system can be controlled in advance before the vehicle 100 reaches the predetermine stop location to avoid or reduce boil-off losses. The control strategy is based on the current level of the hydrogen storage system, the required usage of hydrogen to reach the predetermine stop location and the maximum hydrogen level to prevent hydrogen boil-off losses at stop location, so boil-off losses is prevented or reduced to the utmost extent. By controlling the hydrogen consumption or the hydrogen refueling level before the vehicle 100 reaches the predetermine stop location, the maximum hydrogen level to prevent hydrogen boil-off losses at stop location is not exceeded, so the maximum tank pressure will not be reached, and venting gaseous hydrogen to outside is avoided. The control method can be implemented in software and based on data and information. No extra cost on hardware. No modification and weight added to the hydrogen storage system, and the space for hydrogen storage is not reduced.

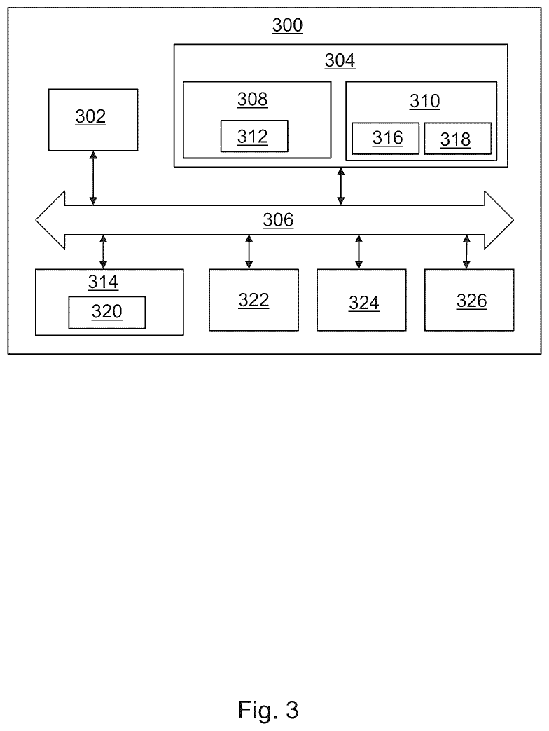

FIG. 3 is a schematic diagram of a computer system 300 for implementing examples disclosed herein. The computer system 300 is adapted to execute instructions from a computer-readable medium to perform these and/or any of the functions or processing described herein. The computer system 300 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 300 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 300 may comprise at least one computing device or electronic device capable of including firmware, hardware, and/or executing software instructions to implement the functionality described herein. The computer system 300 may include processing circuitry 302 (e.g., processing circuitry including one or more processor devices or control units), a memory 304, and a system bus 306. The computer system 300 may include at least one computing device having the processing circuitry 302. The system bus 306 provides an interface for system components including, but not limited to, the memory 304 and the processing circuitry 302. The processing circuitry 302 may include any number of hardware components for conducting data or signal processing or for executing computer code stored in memory 304. The processing circuitry 302 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 302 may further include computer executable code that controls operation of the programmable device.

The system bus 306 may be any of several types of bus structures that may further interconnect to a memory bus (with or without a memory controller), a peripheral bus, and/or a local bus using any of a variety of bus architectures. The memory 304 may be one or more devices for storing data and/or computer code for completing or facilitating methods described herein. The memory 304 may include database components, object code components, script components, or other types of information structure for supporting the various activities herein. Any distributed or local memory device may be utilized with the systems and methods of this description. The memory 304 may be communicably connected to the processing circuitry 302 (e.g., via a circuit or any other wired, wireless, or network connection) and may include computer code for executing one or more processes described herein. The memory 304 may include non-volatile memory 308 (e.g., read-only memory (ROM), erasable programmable read-only memory (EPROM), electrically erasable programmable read-only memory (EEPROM), etc.), and volatile memory 310 (e.g., random-access memory (RAM)), or any other medium which can be used to carry or store desired program code in the form of machine-executable instructions or data structures and which can be accessed by a computer or other machine with processing circuitry 302. A basic input/output system (BIOS) 312 may be stored in the non-volatile memory 308 and can include the basic routines that help to transfer information between elements within the computer system 300.

The computer system 300 may further include or be coupled to a non-transitory computer-readable storage medium such as the storage device 314, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 314 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 314 and/or in the volatile memory 310, which may include an operating system 316 and/or one or more program modules 318. All or a portion of the examples disclosed herein may be implemented as a computer program 320 stored on a transitory or non-transitory computer-usable or computer-readable storage medium (e.g., single medium or multiple media), such as the storage device 314, which includes complex programming instructions (e.g., complex computer-readable program code) to cause the processing circuitry 302 to carry out actions described herein. Thus, the computer-readable program code of the computer program 320 can comprise software instructions for implementing the functionality of the examples described herein when executed by the processing circuitry 302. In some examples, the storage device 314 may be a computer program product (e.g., readable storage medium) storing the computer program 320 thereon, where at least a portion of a computer program 320 may be loadable (e.g., into a processor) for implementing the functionality of the examples described herein when executed by the processing circuitry 302. The processing circuitry 302 may serve as a controller or control system for the computer system 300 that is to implement the functionality described herein.

The computer system 300 may include an input device interface 322 configured to receive input and selections to be communicated to the computer system 300 when executing instructions, such as from a keyboard, mouse, touch-sensitive surface, etc. Such input devices may be connected to the processing circuitry 302 through the input device interface 322 coupled to the system bus 306 but can be connected through other interfaces, such as a parallel port, an Institute of Electrical and Electronic Engineers (IEEE) 1394 serial port, a Universal Serial Bus (USB) port, an IR interface, and the like. The computer system 300 may include an output device interface 324 configured to forward output, such as to a display, a video display unit (e.g., a liquid crystal display (LCD) or a cathode ray tube (CRT)). The computer system 300 may include a communications interface 326 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Some examples are listed in the following:

Example 1: A control system (110) for controlling a state of hydrogen charge in a hydrogen storage system (120) comprised in a vehicle (100) to prevent hydrogen boil-off losses, wherein the control system (110) is configured to:
obtain information about a predetermined stop duration and location for the vehicle (100);
obtain information on a required hydrogen usage for reaching the predetermined stop location from a current location of the vehicle (100);
obtain information on a maximum hydrogen level (121) of the hydrogen storage system (120) to prevent hydrogen boil-off losses when the vehicle (100) reaches the predetermined stop location and the stop duration starts; and
generate a control signal to control the state of hydrogen charge of the hydrogen storage system (120) based on a current hydrogen level (122) in the hydrogen storage system (120) when the vehicle (100) is at the current location, the required hydrogen usage for reaching the predetermined stop location and the maximum hydrogen level (121) of the hydrogen storage system (120) to prevent hydrogen boil-off losses such that the hydrogen level in the hydrogen storage system (120) when the vehicle reaches the predetermined stop location is equal or less than the maximum hydrogen level (121) of the hydrogen storage system to prevent hydrogen boil-off losses.

Example 2: The control system (110) according to Example 1, wherein the control system (110) is configured to generate a control signal to control the state of hydrogen charge of the hydrogen storage system (120) by:
controlling a refueling level of the hydrogen storage system; or
controlling hydrogen consumption of the vehicle (100).

Example 3: The control system (110) according to any one of Examples 1-2, wherein the control system (110) is configured to:
calculate a difference between the current hydrogen level in the hydrogen storage system (122) and the required hydrogen usage for reaching the predetermined stop location;
if the difference is larger than the maximum hydrogen level (121) of the hydrogen storage system (120) to prevent hydrogen boil-off losses,
generate a control signal to increase hydrogen consumption in the vehicle (100), or if the vehicle (100) is at a refueling station, the control system (110) is configured to generate a control signal to stop hydrogen refueling;
if the difference is smaller than the maximum hydrogen level (121) in the hydrogen storage system to prevent hydrogen boil-off losses and the vehicle (100) is at a refueling station,
generate a control signal to control the refueling level of the hydrogen storage system.

Example 4: The control system (110) according to Example 3, wherein the control system (110) is configured to:
determine a maximum refueling hydrogen level based on the difference; and
inform a user and/or a vehicle system and/or a fuel station system about the maximum refueling hydrogen level such that the hydrogen refueling is stopped before or when the maximum refueling hydrogen level is reached.

Example 5: The control system (110) according to Example 2, wherein the control system (110) is configured to:
determine a maximum refueling hydrogen level based on the current hydrogen level (122), the required hydrogen usage for reaching the predetermined stop location and the maximum hydrogen level (121) to prevent hydrogen boil-off; and
inform a user and/or a vehicle system and/or a fuel station system about the maximum refueling hydrogen level such that the refueling is stopped before or when the maximum refueling hydrogen level is reached.

Example 6: The control system (110) according to Example 3, wherein the control system (110) is configured to generate a control signal to increase hydrogen consumption in the vehicle (100) based on the difference by charging an energy storage system (130) of the vehicle (120).

Example 7: The control system (110) according to Example 6, wherein the energy storage system (130) is charged such that the hydrogen level in the hydrogen storage system (120) when the vehicle (100) reaches the predetermined stop location is lower than or equal to the maximum hydrogen level (121) in the hydrogen storage system (120) to prevent hydrogen boil-off; or
the energy storage system (130) is charged as much as possible until the vehicle (100) reaches the predetermined stop location.

Example 8: The control system (110) according to any one of Examples 1-7, wherein the hydrogen comprises liquid hydrogen, cryogenic hydrogen, cryo-compressed hydrogen, or any other form of hydrogen that is stored at cryogenic temperatures.

Example 9: The control system (110) according to any one of Examples 1-8, wherein during the predetermined stop duration, the vehicle will not consume any hydrogen stored in the hydrogen storage system.

Example 10: The control system (110) according to any one of Examples 1-9, wherein the control system (110) is configured to calculate the maximum hydrogen level (121) of the hydrogen storage system (120) to prevent hydrogen boil-off losses based on relative parameters such as the predetermined stop duration, the ambient conditions of the hydrogen storage system, the ambient temperature, the type and design of the hydrogen storage system and the thermal or thermodynamic state of the hydrogen storage system.

Example 11: The control system (110) according to any one of Examples 1-9, wherein the control system (110) is configured to determine the maximum hydrogen level (121) of the hydrogen storage system (120) to prevent hydrogen boil-off losses by using a look up table with information on vehicle stopping duration before hydrogen boil-off starts versus state of hydrogen charge of the hydrogen storage system, or by using a pre-built model based on a type and design of the hydrogen storage system (120) with relative parameters related to e.g. stopping duration, current state of hydrogen charge and ambient condition of the hydrogen storage system.

Example 12: The control system (110) according to any one of Examples 1-9, wherein the control system (110) is configured to receive the maximum hydrogen level (121) of the hydrogen storage system (120) to prevent hydrogen boil-off losses from another system on board of the vehicle or from a central system (150).

Example 13: The control system (110) according to any one of Examples 1-12, wherein the control system (110) is configured to determine the required hydrogen usage for reaching the predetermined stop location by being configured to use information about the predetermined stop location, map information and information about hydrogen consumption calculated by another system on board of the vehicle.

Example 14: A vehicle (100) comprising a control system (110) according to any one of Examples 1-13.

Example 15: A method for controlling a state of hydrogen charge in a hydrogen storage system of a vehicle, the method comprising:
obtaining (210) information about a predetermined stop duration and location for the vehicle (100);
obtaining (220) information on a required hydrogen usage for reaching the predetermined stop location from a current location of the vehicle (100);
obtaining (230) information on a maximum hydrogen level (121) of the hydrogen storage system (120) to prevent hydrogen boil-off losses when the vehicle (100) reaches the predetermined stop location and the stop duration starts; and
generating (240) a control signal for controlling the state of hydrogen charge of the hydrogen storage system (120) based on a current hydrogen level (122) in the hydrogen storage system (120) when the vehicle (100) is at the current location, the required hydrogen usage for reaching the predetermined stop location and the maximum hydrogen level (121) of the hydrogen storage system (120) to prevent hydrogen boil-off losses such that the hydrogen level in the hydrogen storage system (120) when the vehicle reaches the predetermined stop location is equal or less than the maximum hydrogen level (121) in the hydrogen storage system to prevent hydrogen boil-off.

Example 16: The method according to Example 15, wherein controlling (240) the state of hydrogen charge of the hydrogen storage system (120) comprises:
controlling a refueling level (241) of the hydrogen storage system; or
controlling hydrogen consumption (242) of the vehicle (100).

Example 17: The method according to Example 16, further comprises:
determining a maximum refueling hydrogen level based on a difference between the current hydrogen level in the hydrogen storage system (120) and the required hydrogen usage for reaching the predetermined stop location; or determining a maximum refueling hydrogen level based on the current hydrogen level (122), the required hydrogen usage for reaching the predetermined stop location and the maximum hydrogen level (121) to prevent hydrogen boil-off; and
informing a user and/or a vehicle system and/or a fuel station system about the maximum refueling hydrogen level such that the hydrogen refueling is stopped before or when the maximum refueling hydrogen level is reached.

Example 18: The method according to Example 16, wherein controlling hydrogen consumption (242) of the vehicle (100) comprises:
charging the energy storage system (130) such that the hydrogen level in the hydrogen storage system (120) when the vehicle (100) reaches the predetermined stop location is lower than or equal to the maximum hydrogen level (121) in the hydrogen storage system (120) to prevent hydrogen boil-off; or
charging the energy storage system (130) as much as possible until the vehicle (100) reaches the predetermined stop location.

Example 19: The method according to any one of Examples 15-18, wherein obtaining (230) information on a maximum hydrogen level (121) of the hydrogen storage system (120) to prevent hydrogen boil-off losses comprises any one of the following:
calculating (231) the maximum hydrogen level (121) of the hydrogen storage system (120) to prevent hydrogen boil-off losses based on relative parameters such as the predetermined stop duration, the ambient conditions of the hydrogen storage system, the ambient temperature, the type and design of the hydrogen storage system and the thermal or thermodynamic state of the hydrogen storage system;
determining (232) the maximum hydrogen level (121) of the hydrogen storage system (120) to prevent hydrogen boil-off losses by using a look up table with information on vehicle stopping duration before hydrogen boil-off starts versus state of hydrogen charge of the hydrogen storage system, or by using a pre-built model based on a type and design of the hydrogen storage system (120) with relative parameters related to e.g. stopping duration, current state of hydrogen charge and ambient condition of the hydrogen storage system;
receiving (233) the maximum hydrogen level (121) of the hydrogen storage system (120) to prevent hydrogen boil-off losses from another system on board of the vehicle or from a central system (150).

Example 20: A computer program product comprising program code for performing, when executed by the processing circuitry, the method of any of examples 15-19.

Example 21: A non-transitory computer-readable storage medium comprising instructions, which when executed by the processing circuitry, cause the processing circuitry to perform the method of any of examples 15-19.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A control system for controlling a state of hydrogen charge in a hydrogen storage system comprised in a vehicle to prevent hydrogen boil-off losses, wherein the control system is configured to:
obtain information about a predetermined stop duration and location for the vehicle;
obtain information on a required hydrogen usage for reaching the predetermined stop location from a current location of the vehicle;
obtain information on a maximum hydrogen level of the hydrogen storage system to prevent hydrogen boil-off losses when the vehicle reaches the predetermined stop location and the stop duration starts; and
generate a control signal for controlling the state of hydrogen charge of the hydrogen storage system based on a current hydrogen level in the hydrogen storage system when the vehicle is at the current location, the required hydrogen usage for reaching the predetermined stop location and the maximum hydrogen level of the hydrogen storage system to prevent hydrogen boil-off losses such that the hydrogen level in the hydrogen storage system when the vehicle reaches the predetermined stop location is equal or less than the maximum hydrogen level in the hydrogen storage system to prevent hydrogen boil-off.

2. The control system of claim 1, wherein the control system is configured to generate a control signal for controlling the state of hydrogen charge of the hydrogen storage system by:
controlling a refueling level of the hydrogen storage system; or
controlling hydrogen consumption of the vehicle.

3. The control system of claim 1, wherein the control system is configured to:
calculate a difference between the current hydrogen level in the hydrogen storage system and the required hydrogen usage for reaching the predetermined stop location;
if the difference is larger than the maximum hydrogen level in the hydrogen storage system to prevent hydrogen boil-off, the control system is configured to generate a control signal to increase hydrogen consumption in the vehicle, or if the vehicle is at a refueling station, the control system is configured to generate a control signal to stop hydrogen refueling; and
if the difference is smaller than the maximum hydrogen level in the hydrogen storage system to prevent hydrogen boil-off losses and the vehicle is at a refueling station, the control system is configured to generate a control signal to control the refueling level of the hydrogen storage system based on the difference.

4. The control system of claim 3, wherein the control system is configured to:
determine a maximum refueling hydrogen level based on the current hydrogen level, the required hydrogen usage for reaching the predetermined stop location and the maximum hydrogen level to prevent hydrogen boil-off losses or determine a maximum refueling hydrogen level based on the difference between the current hydrogen level in the hydrogen storage system and the required hydrogen usage for reaching the predetermined stop location; and
inform at least one of a user, a vehicle system, and a fuel station system about the maximum refueling hydrogen level such that the hydrogen refueling is stopped before or when the maximum refueling hydrogen level is reached.

5. The control system of claim 3, wherein the control system is configured to generate a control signal to increase hydrogen consumption in the vehicle by:
charging the energy storage system such that the hydrogen level in the hydrogen storage system when the vehicle reaches the predetermined stop location is lower than or equal to the maximum hydrogen level in the hydrogen storage system to prevent hydrogen boil-off; or
charging the energy storage system as much as possible until the vehicle reaches the predetermined stop location.

6. The control system of claim 1, wherein the hydrogen comprises liquid hydrogen, cryogenic hydrogen, cryo-compressed hydrogen, or any other form of hydrogen that is stored at cryogenic temperatures.

7. The control system of claim 1, wherein the control system is configured to any one of the following:
calculate the maximum hydrogen level of the hydrogen storage system to prevent hydrogen boil-off losses based on relative parameters related to the predetermined stop duration, the ambient conditions of the hydrogen storage system, the ambient temperature, the type and design of the hydrogen storage system and the thermal or thermodynamic state of the hydrogen storage system;
determine the maximum hydrogen level of the hydrogen storage system to prevent hydrogen boil-off losses by using a look up table with information on vehicle stopping duration before hydrogen boil-off starts versus state of hydrogen charge of the hydrogen storage system, or by using a pre-built model based on a type and design of the hydrogen storage system with relative parameters; or
receive the maximum hydrogen level of the hydrogen storage system to prevent hydrogen boil-off losses from another system on board of the vehicle or from a central system.

8. A vehicle comprising the control system of claim 1.

9. A computer-implemented method for controlling a state of hydrogen charge in a hydrogen storage system of a vehicle, the method comprising:
obtaining, by a processing circuitry of a computer system, information about a predetermined stop duration and location for the vehicle;
obtaining, by the processing circuitry, information on a required hydrogen usage for reaching the predetermined stop location from a current location of the vehicle;
obtaining, by the processing circuitry, information on a maximum hydrogen level of the hydrogen storage system to prevent hydrogen boil-off losses when the vehicle reaches the predetermined stop location and the stop duration starts; and
generating, by the processing circuitry, a control signal for controlling, the state of hydrogen charge of the hydrogen storage system based on a current hydrogen level in the hydrogen storage system when the vehicle is at the current location, the required hydrogen usage for reaching the predetermined stop location and the maximum hydrogen level of the hydrogen storage system to prevent hydrogen boil-off losses such that the hydrogen level in the hydrogen storage system when the vehicle reaches the predetermined stop location is equal or less than the maximum hydrogen level in the hydrogen storage system to prevent hydrogen boil-off losses.

10. The method of claim 9, wherein controlling the state of hydrogen charge of the hydrogen storage system comprises:
controlling a refueling level of the hydrogen storage system; or
controlling hydrogen consumption of the vehicle.

11. The method of claim 10, further comprising:
determining, by the processing circuitry, a maximum refueling hydrogen level based on a difference between the current hydrogen level in the hydrogen storage system and the required hydrogen usage for reaching the predetermined stop location; or determining a maximum refueling hydrogen level based on the current hydrogen level, the required hydrogen usage for reaching the predetermined stop location and the maximum hydrogen level to prevent hydrogen boil-off; and
informing, by the processing circuitry, at least one of a user, a vehicle system, and a fuel station system about the maximum refueling hydrogen level such that the hydrogen refueling is stopped before or when the maximum refueling hydrogen level is reached.

12. The method according to claim 10, wherein controlling hydrogen consumption of the vehicle comprises:
charging the energy storage system such that the hydrogen level in the hydrogen storage system when the vehicle reaches the predetermined stop location is lower than or equal to the maximum hydrogen level in the hydrogen storage system to prevent hydrogen boil-off; or
charging the energy storage system as much as possible until the vehicle reaches the predetermined stop location.

13. The method of claim 9, wherein obtaining, by the processing circuitry, information on a maximum hydrogen level of the hydrogen storage system to prevent hydrogen boil-off losses comprises any one of the following:
calculating, by the processing circuitry, the maximum hydrogen level of the hydrogen storage system to prevent hydrogen boil-off losses based on relative parameters related to the predetermined stop duration, the ambient conditions of the hydrogen storage system, the ambient temperature, the type and design of the hydrogen storage system and the thermal or thermodynamic state of the hydrogen storage system;
determining, by the processing circuitry, the maximum hydrogen level of the hydrogen storage system to prevent hydrogen boil-off losses by using a look up table with information on vehicle stopping duration before hydrogen boil-off starts versus state of hydrogen charge of the hydrogen storage system, or by using a pre-built model based on a type and design of the hydrogen storage system with relative parameters related to stopping duration, current state of hydrogen charge and ambient condition of the hydrogen storage system; or
receiving, by the processing circuitry, the maximum hydrogen level of the hydrogen storage system to prevent hydrogen boil-off losses from another system on board of the vehicle or from a central system.

14. A computer program product comprising program code for performing, when executed by the processing circuitry, the method of claim 9.

15. A non-transitory computer-readable storage medium comprising instructions, which when executed by the processing circuitry, cause the processing circuitry to perform the method of claim 9.
